(19) United States
(12) Patent Application Publication
(10) Pub. No.: US 2022/0232137 A1
(43) Pub. Date: Jul. 21, 2022

(54) IMAGE READING APPARATUS AND IMAGE FORMING SYSTEM

(71) Applicant: CANON KABUSHIKI KAISHA, Tokyo (JP)

(72) Inventors: Michiaki Endo, Chiba (JP); Kiyoshi Watanabe, Chiba (JP)

(21) Appl. No.: 17/574,916

(22) Filed: Jan. 13, 2022

(30) Foreign Application Priority Data
Jan. 20, 2021 (JP) 2021-007005

(51) Int. Cl. H04N 1/00; H04N 1/12

(52) U.S. Cl. CPC H04N 1/00572; H04N 1/00615; H04N 1/1235

(57) ABSTRACT

An image reading apparatus reads an image of a sheet conveyed from an image forming apparatus. The image reading apparatus includes a transparent member including a first surface disposed on a first side on which the sheet is conveyed and a second surface disposed on a second side opposite to the first side, an image reading portion disposed on the second side and configured to read the image of the sheet at a reading position through the transparent member, an elastic member disposed to abut against the second surface of the transparent member and configured to press the transparent member toward the first side, and a guide disposed upstream of the reading position and configured to guide the sheet to the reading position. A downstream end of the guide contacts with the first surface of the transparent member and presses the transparent member toward the second side.

### BACKGROUND OF THE DISCLOSURE

### Field of the Disclosure

The present disclosure relates to an image reading apparatus and an image forming system.

### Description of the Related Art

Conventionally, in order to improve image quality, an inspection apparatus incorporating an image reading apparatus has been devised as a device configured to read an image output from an image forming apparatus such as a copying machine and to detect the presence or absence of a defect in the image. The inspection apparatus reads an image data printed on a sheet while conveying a recording material (hereinafter referred to as a sheet) such as a sheet of paper on a reading glass. Further, Japanese Patent Application Laid-Open No. H11-69043 discloses an image reading apparatus in which a guide configured to introduce a sheet is provided on the upstream side of the reading glass in the sheet conveyance direction in order to smoothly pass the sheet onto the reading glass.

However, if there is a gap between the reading glass and the image reading apparatus, a foreign substance such as paper dust and dirt may enter through the gap. When the foreign substance adheres to a back side of the reading glass or a sensor of the image reading apparatus, the foreign substance is included as noise in an image data read by the image reading apparatus. Therefore, good image data cannot be obtained. To this end, it is conceivable to arrange an elastic member such as a sponge made of a foamed material for preventing intrusion of foreign substance in the gap between the reading glass and the image reading apparatus. By disposing the sponge in a squeezed state between the reading glass and the image reading apparatus, the intrusion path of the foreign substance can be blocked.

However, the reaction force of the squeezed sponge deflects the reading glass toward an opposed member. When the reading glass is deflected, a gap between the reading glass and the opposed member becomes smaller than a set distance. Therefore, a focus position of the image reading apparatus is shifted, which causes an issue of not being able to obtain good reading data.

### SUMMARY OF THE DISCLOSURE

This disclosure improves image reading performance by reducing deflection of the reading glass.

An image reading apparatus configured to read an image of a sheet conveyed from an image forming apparatus configured to form the image on the sheet, the image reading apparatus comprising: a conveyance portion configured to convey the sheet in a conveyance direction; a transparent member including a first surface disposed on a first side on which the sheet is conveyed by the conveyance portion and a second surface disposed on a second side opposite to the first side; an image reading portion disposed on the second side with respect to the transparent member and configured to read the image of the sheet through the transparent member; an elastic member disposed to abut against the second surface of the transparent member on the second side and configured to press the transparent member toward the first side; and a guide disposed upstream of a reading position where the image reading portion reads the image of the sheet with respect to the conveyance direction and configured to guide the sheet conveyed by the conveyance portion to the reading position, wherein the guide is provided so that a downstream end of the guide with respect to the conveyance direction contacts with the first surface of the transparent member and presses the transparent member toward the second side.

Further features of the present disclosure will become apparent from the following description of exemplary embodiments with reference to the attached drawings.

### BRIEF DESCRIPTION OF THE DRAWINGS

FIG. 1 is a view showing an image forming system.

FIG. 2 is a cross-sectional view of a first image reading apparatus and a second image reading apparatus.

FIG. 3 is an explanatory view of a first image reading process portion.

FIG. 4 is a cross-sectional view of the first image reading process portion taken along line IV-IV of FIG. 3.

FIG. 5 is an explanatory view of a focal position of a CIS.

FIG. 6 is an explanatory view of a gap between a reading glass and a backing roller.

FIG. 7 is an explanatory view of a deflecting of a sheet in a case in which an introduction guide of a reference example is used.

FIG. 8 is an explanatory view of a deflecting of a sheet in a case in which an introduction guide of the embodiment is used.

FIG. 9 is a view of an introduction guide fixed to a frame.

FIG. 10 is a perspective view of a first image reading apparatus.

FIG. 11 is a perspective view of a first image reading apparatus in which a frame, an introduction guide and a backing roller are assembled.

### DESCRIPTION OF THE EMBODIMENTS

The embodiments will be described in exemplary detail with reference to the drawings below. However, the dimensions, materials and shapes of the components described in the embodiments should be appropriately changed according to the configuration of the apparatus to which the disclosure is applied and various conditions, and the scope of the disclosure is not limited to the following embodiments.

(Image Forming System)

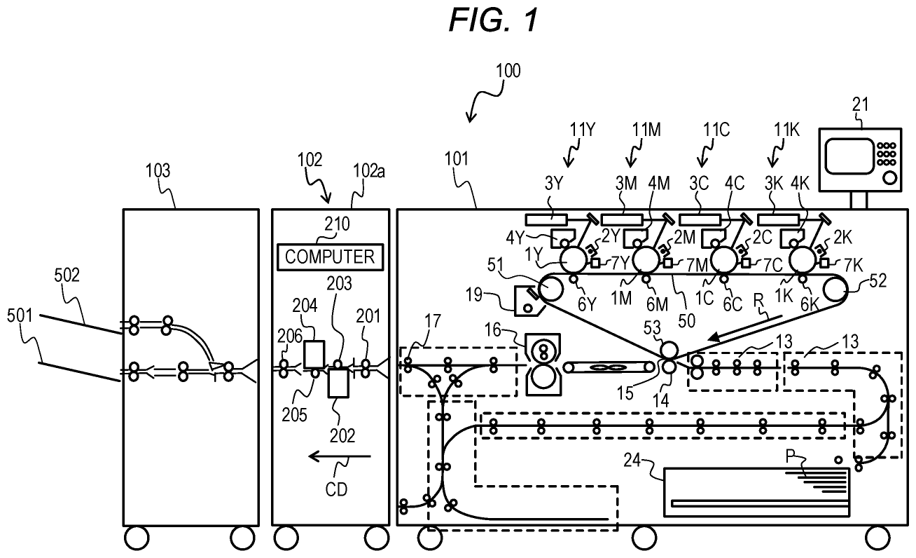

FIG. 1 is a view showing an image forming system 100. The image forming system 100 includes a printer 101, an inspection apparatus (an image reading apparatus) 102, and an output sheet sorting device (hereinafter referred to as a sorter) 103. The printer 101 is an image forming apparatus configure to form an image on a sheet (recording material) P. The inspection apparatus 102 is connected to the printer 101 downstream of the printer 101 with respect to a conveyance direction CD of the sheet P. The sorter 103 is connected to the inspection apparatus 102 downstream of the inspection apparatus 102 with respect to the conveyance direction CD of the sheet P.

(Image Forming Apparatus)

The printer 101 is a four-color full-color printer using an electrophotographic process. The printer 101 forms an image on the sheet P based on an image signal inputted to a control unit (not shown) from an information terminal (not shown) such as a personal computer (not shown) or an external device (not shown) such as an image reader (not shown), and discharges the sheet P on which the image is formed. The sheet P is a recording material on which an image is formed with toner. The sheet P includes, for example, plain paper, cardboard, transparencies, coated paper, and label paper. An operator operates the printer 101 through an operation portion 21.

The printer 101 has four image forming portions 11Y, 11M, 11C and 11K provided side by side. The image forming portion 11Y forms a yellow (Y) toner image. The image forming portion 11M forms a magenta (M) toner image. The image forming portion 11C forms a cyan (C) toner image. The image forming portion 11K forms a black (K) toner image. Laser scanner units 3Y, 3M, 3C, and 3K as exposure apparatuses are arranged in the upper portions of the image forming portions 11Y, 11M, 11C, and 11K, respectively. The image forming portions 11Y, 11M, 11C and 11K are provided with electrophotographic photosensitive drums 1Y, 1M, 1C and 1K as image bearing members, chargers 2Y, 2M, 2C and 2K, and developing units 4Y, 4M, 4C and 4K, respectively. The image forming portions 11Y, 11M, 11C and 11K further have drum cleaners 7Y, 7M, 7C and 7K, respectively.

An intermediate transfer belt 50 is disposed below the image forming portions 11Y, 11M, 11C and 11K. The intermediate transfer belt 50 is stretched over a drive roller 51, a tension roller 52 and a secondary transfer inner roller 53, and is rotated in a direction indicated by an arrow R. The primary transfer rollers 6Y, 6M, 6C, and 6K are disposed opposite to the electrophotographic photosensitive drums 1Y, 1M, 1C, and 1K, respectively, via the intermediate transfer belt 50. The image forming portions 11Y, 11M, 11C and 11K have substantially the same structure except for the color of the toner contained in the developing units 4Y, 4M, 4C and 4K.

The chargers 2Y, 2M, 2C, and 2K uniformly charge surfaces of the electrophotographic photosensitive drums 1Y, 1M, 1C, and 1K, respectively. The laser scanner units 3Y, 3M, 3C, and 3K expose the uniformly charged surfaces of the electrophotographic photosensitive drums 1Y, 1M, 1C, and 1K according to image signals of respective colors to form electrostatic latent images. The developing units 4Y, 4M, 4C, and 4K develop the electrostatic latent images formed on the surfaces of the electrophotographic photosensitive drums 1Y, 1M, 1C, and 1K with toners of respective colors to form toner images of yellow, magenta, cyan, and black. The yellow, magenta, cyan and black toner images are transferred on the intermediate transfer belt 50 by the primary transfer rollers 6Y, 6M, 6C and 6K and superimposed on top of one another.

On the other hand, sheets P are fed one by one from a cassette 24 and conveyed through a conveyance path 13 to a secondary transfer nip portion 15 formed between the intermediate transfer belt 50 and a secondary transfer roller 14 at a predetermined control timing. The toner images of the four colors on the intermediate transfer belt 50 are collectively transferred to a sheet P by the secondary transfer nip portion 15. A transfer residual toner remaining on the intermediate transfer belt 50 after the secondary transfer is removed from the surface of the intermediate transfer belt 50 by a belt cleaner 19. The sheet P on which the toner image is transferred is conveyed to a fixing device 16. The fixing device 16 heats and pressurizes the sheet P to fix the toner image on the sheet P. A sheet P on which a full color image is formed is discharged from the printer 101 by a pair of discharge rollers 17.

(Inspection Apparatus)

The sheet P discharged from the printer 101 is delivered to the inspection apparatus 102 connected downstream of the printer 101. The inspection apparatus 102 is a device configured to detect the presence/absence of abnormality of print information of the sheet P discharged from the printer 101. The inspection apparatus 102 has a first image reading apparatus 202 configured to read an image formed on one side of the sheet P and a second image reading apparatus 204 configured to read an image formed on the other side of the sheet P. First, a sheet P on which reference images are formed is conveyed to the inspection apparatus 102. The first image reading apparatus 202 and the second image reading apparatus 204 read the reference images formed on the sheet P, and register (save) the images as the reference images in a computer 210 connected to the inspection apparatus 102.

Thereafter, the inspection apparatus 102 reads the images of the sheet P conveyed from the printer 101 by the first image reading apparatus 202 and the second image reading apparatus 204. The computer (an inspection portion) 210 performs image inspection by comparing the read images with the reference images. The image information of the read sheet P is compared with the image information of the reference images registered in advance, and an existence of a difference between the images formed by the printer 101 and the reference images is determined. Based on the difference between the image information of the images formed by the printer 101 and the image information of the reference images, it is determined whether or not the image formed on the sheet P by the printer 101 is an abnormal image.

(Sorter)

The sheet P discharged from the inspection apparatus 102 is conveyed to the sorter 103. In a case in which the inspection apparatus 102 determines that there is no abnormality in the image formed on the sheet P discharged from the printer 101, the sorter 103 discharges the sheet P to a tray 501. In a case in which the inspection apparatus 102 determines that there is an abnormality in the image formed on the sheet P discharged from the printer 101, the sorter 103 discharges the sheet P to a tray 502. As a result, a series of image forming, inspection processing and sorting processing by the image forming system 100 is completed.

(Image Reading Apparatus)

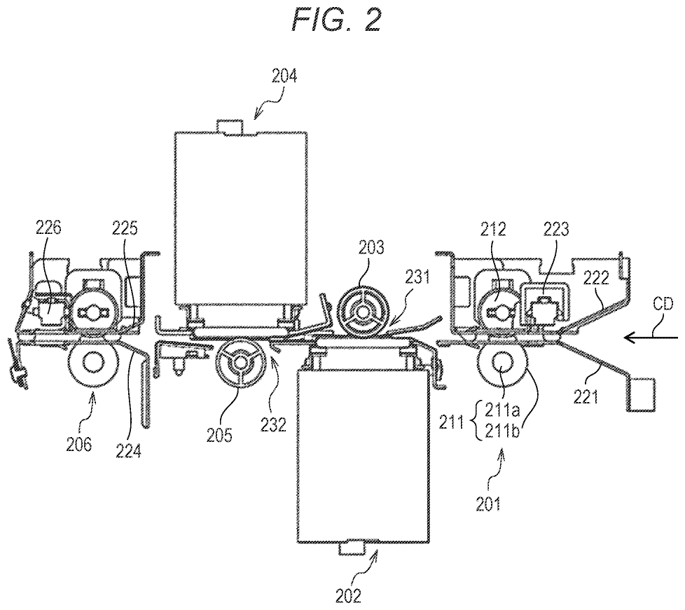

FIG. 2 is a cross-sectional view of the first image reading apparatus 202 and the second image reading apparatus 204. A conveyance of the sheet P (not shown in FIG. 2) in the first image reading apparatus 202 and the second image reading apparatus 204 disposed in the inspection apparatus 102 will be described with reference to FIG. 2. The printer 101 (not shown in FIG. 2) is disposed on the right side of FIG. 2, and the sorter 103 (not shown in FIG. 2) is disposed on the left side of FIG. 2. There is a floor (not shown in FIG. 2) on the lower side of FIG. 2 and a ceiling (not shown in FIG. 2) on the upper side of FIG. 2. The sheet P is conveyed in the conveyance direction CD.

The inspection apparatus 102 has an inlet lower guide 221 and an inlet upper guide 222. The inlet lower guide 221 and the inlet upper guide 222 suppress the fluttering of the sheet P caused by the conveyance of the sheet P entering the inspection apparatus 102. The material of the inlet lower guide 221 and the inlet upper guide 222 is SUS 420 CP. A polishing process is applied to the contact surfaces of the inlet lower guide 221 and the inlet upper guide 222 with the sheet P to improve the surface properties of the contact surfaces so as not to damage the sheet P. An inlet sensor 223 detects the sheet P entering the inspection apparatus 102. A reflection type photosensor is used as the inlet sensor 223.

Based on a timing at which the inlet sensor 223 detects the sheet P entering the inspection apparatus 102, a timing at which the first image reading apparatus 202 reads the image formed on the one side of the sheet P is controlled. Further, if it is determined based on the detection result of the inlet sensor 223 that there is an abnormality in the conveyance of the sheet P, a jam processing of the sheet P is executed.

A first conveyance roller pair 201 comprises a conveyance roller 211 having a steel shaft 211a attached with two pieces of silicone rubber 211b having an outer diameter of 20 mm, and a rotatable member 212 made of POM resin arranged at a position corresponding to each piece of the silicone rubber 211b. The POM resin is a polyoxymethylene resin or a polyacetal resin. The conveyance roller 211 is rotated by a rotation drive transmitted from a driving motor (not shown) to the end of the conveyance roller 211 via a timing belt (not shown).

The rotatable member 212 is rotatably supported on an axis. The rotatable member 212 is urged against the conveyance roller 211 by an elastic member such as a spring (not shown) with a force of 1.2N. The rotatable member 212 is rotated in association with the rotation of the conveyance roller 211.

The sheet P is conveyed by the conveyance roller 211 to a first image reading process portion 231 comprising the first image reading apparatus 202 and a first backing roller 203. The sheet P is further conveyed by the conveyance roller 211 to a second image reading process portion 232 comprising the second image reading apparatus 204 and a second backing roller 205. The first image reading apparatus 202 and the first backing roller 203 have the same structures as the second image reading apparatus 204 and the second backing roller 205, respectively. The first image reading apparatus 202 is arranged below the conveyance path for the sheet P. The second image reading apparatus 204 is arranged above the conveyance path for the sheet P. The first image reading apparatus 202 and the second image reading apparatus 204 are arranged opposite to each other with respect to the conveyance path. The first image reading apparatus 202 and the second image reading apparatus 204 have different reading directions. Therefore, the first image reading apparatus 202 and the second image reading apparatus 204 can read image information of images formed on both sides (front side and back side) of the sheet P only by passing the sheet P through the conveyance path one time without reversing the sheet P in another conveyance path.

The sheet P passed through the second image reading apparatus 204 is guided by an outlet lower guide 224 and an outlet upper guide 225, and is discharged from the inspection apparatus 102 by a second conveyance roller pair 206 and conveyed to the sorter 103. The material of the outlet lower guide 224 and the outlet upper guide 225 is SUS 420 CP. The polishing process is applied to the contact surfaces of the outlet lower guide 224 and the outlet upper guide 225 with the sheet P to improve the surface properties of the contact surfaces so as not to damage the sheet P. Since the second conveyance roller pair 206 has the same structure as the first conveyance roller pair 201, a description thereof will be omitted. An outlet sensor 226 detects the sheet P discharged from the inspection apparatus 102. Since the outlet sensor 226 has the same structure as the inlet sensor 223, a description thereof will be omitted.

A conveyance speed of the sheet P conveyed by the first pair of conveyance rollers (conveyance portion) 201 is the same as a conveyance speed of the sheet P discharged from the printer 101. A line connecting a nip of the first conveyance roller pair 201 and a nip of the second conveyance roller pair 206 is arranged so as to substantially coincide with a sheet-passing surface through the first image reading apparatus 202 and a sheet-passing surface through the second image reading apparatus 204. The reason is to keep the sheet P conveyed in the inspection apparatus 102 straight so as not to apply deflecting stress to the sheet P.

In a case in which the conveyance path of the sheet P is bent, the deformation stress to the sheet P increases at the bent point, so that an issue occurs in that the image formed on the sheet P is damaged or the paper dust is generated. In a case in which the image of the sheet P is damaged or the paper dust is generated, noise is mixed in the read image information of the sheet P so that good read image information cannot be obtained. Therefore, the conveyance path of the sheet P is configured so as not to cause the above-mentioned issue.

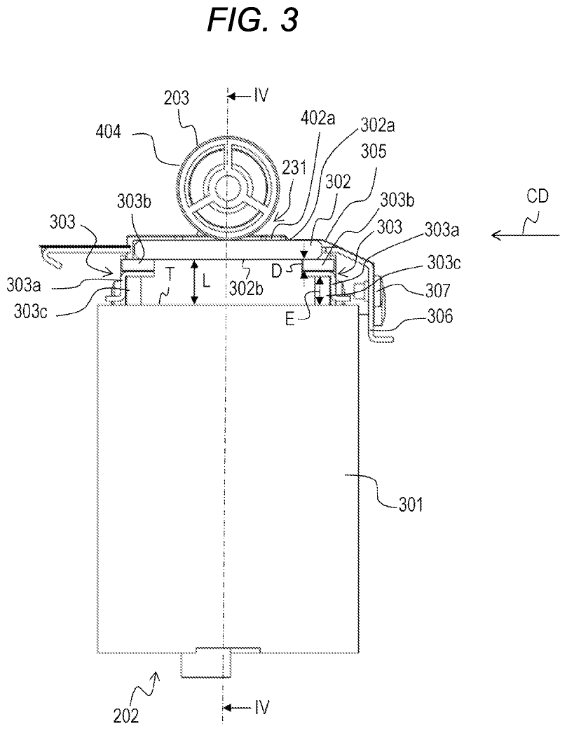

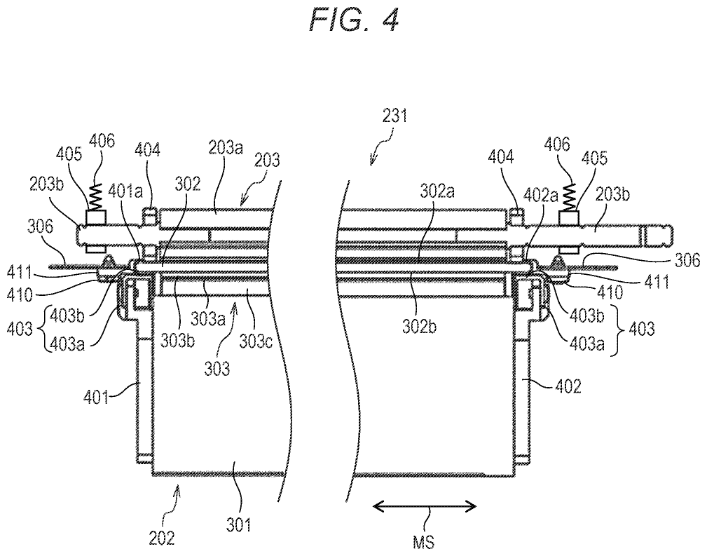

FIG. 3 is an explanatory view of the first image reading process portion 231. The first image reading process portion 231 comprises the first image reading apparatus 202 and the first backing roller 203 provided in the inspection apparatus 102. The printer 101 is disposed on the right side of FIG. 3. The sorter 103 is disposed on the left side of FIG. 3. The floor is below FIG. 3 and the ceiling is above FIG. 3. FIG. 4 is a cross-sectional view of the first image reading process portion 231 taken along line IV-IV of FIG. 3.

The first image reading apparatus 202 includes a contact image sensor (hereinafter referred to as CIS) 301 serving as an image reading portion. A reading glass (transparent member) 302 is disposed at a predetermined distance L from an upper surface T of the CIS 301. In the present embodiment, the predetermined distance L is 13.1 mm, but the present disclosure is not limited thereto. In the present embodiment, the thickness of the reading glass 302 is 3.9 mm, but the present disclosure is not limited thereto. The reading glass 302 has a length of 38 mm in the conveyance direction CD of the sheet P and a length of 366 mm in a main scanning direction MS orthogonal to the conveyance direction CD. The first image reading apparatus 202 is arranged opposite to the reading glass 302 on a side (second side) opposite to a side (first side) on which the sheet P is conveyed with respect to the reading glass 302, and reads an image of the sheet P conveyed on the reading glass 302.

A surface treatment is applied to the sheet-passing surface (passing surface) 302a of the reading glass 302 on which the sheet P passes in order to eliminate elements that obstruct the conveyance property of the sheet P such as sticking of the sheet P to the sheet-passing surface 302a. As described above, the sheet-passing surface 302a of the reading glass 302 has the same level as the line connecting the nip of the first conveyance roller pair 201 and the nip of the second conveyance roller pair 206.

A dustproof plate 303 configured to prevent intrusion of foreign substance is arranged between the CIS 301 and the reading glass 302. The dustproof plate 303 includes a steel plate 303a of ZINKOTE (trademark) having a thickness of 1 mm, and foamed urethane sponges (elastic members) 303b and 303c fixed to the steel plate 303a by double-sided adhesive tape. The sponge 303b is disposed between the steel plate 303a and a non-sheet-passing surface 302b of the reading glass 302. The sponge 303c is disposed between the steel plate 303a and an upper surface T of the CIS 301. The dustproof plate 303 including sponges 303a and 303b extends in the main scanning direction along the reading glass 302.

In order to smoothly deliver the sheet P conveyed from the first conveyance roller pair 201 to the sheet-passing surface 302a of the reading glass 302, an introduction guide 305 is provided on the upstream side of the reading glass 302 in the conveyance direction CD. The introduction guide 305 is made of a spring material (elastic material) made of SUS 304 CSP-1/2H having a thickness of 0.1 mm. One end of the introduction guide 305 is fixed to a frame 306 by screws 307, and the other end (free end) of the introduction guide 305 is disposed so as to be in close contact with the upper surface of the reading glass 302. A portion of the frame 306 is a supporting member of the introduction guide 305 and also serves as a sheet guide configured to guide the sheet P.

CIS holders 401 and 402 made of aluminum as holding members configured to hold the CIS 301 are fixed to both ends of the CIS 301 with respect to the main scanning direction MS by screws. The CIS holders 401 and 402 also hold the reading glass 302 at a predetermined distance (predetermined value) L from the upper surface T of the CIS 301. Positioning portions (butting portions) 401a and 402a having protrusions projecting toward the reading glass 302 are provided on the upper portions of the CIS holders 401 and 402, respectively. The sheet-passing surface 302a of the reading glass 302 is butted against the positioning portions 401a and 402a. As shown in FIG. 4, the non-sheet-passing surface 302b of the reading glass 302 is butted against a pressing member 403. The pressing member 403 includes a steel plate 403a of ZINKOTE (trademark) and a hard rubber (elastic member) 403b. The hard rubber 403b is disposed between the steel plate 403a and the non-sheet-passing surface 302b of the reading glass 302. The pressing member 403 presses the reading glass 302 against the positioning portions 401a and 402a to fix the reading glass 302.

The first backing roller 203 is hereinafter simply referred to as a backing roller 203. The backing roller 203 is disposed so that an outer periphery of the backing roller 203 is separated by a predetermined distance from the sheet-passing surface 302a of the reading glass 302, thereby forming a gap δ between the outer periphery of the backing roller 203 and the sheet-passing surface 302a of the reading glass 302 (FIG. 8). In the embodiment, the predetermined distance is 0.4 mm. However, the predetermined distance is not limited to 0.4 mm, and is appropriately set in accordance with the specifications of the inspection apparatus 102. The backing roller 203 is disposed opposite to the reading glass 302 on the side (the first side) on which the sheet P is conveyed with respect to the reading glass 302. The backing roller 203 functions as a regulating portion (an opposed member) configured to regulate the conveyance of the sheet P so as to properly maintain the distance between the reading glass 302 and the sheet P within a predetermined range. The backing roller 203 has an aluminum pipe material 203a and shafts 203b pressed into both ends of the pipe material 203a. A black urethane coat is applied to an outer peripheral surface of the pipe material 203a. The backing roller 203 has an outer diameter of 20 mm.

At each of both ends of the backing roller 203 with respect to the main scanning direction MS, a butt roller 404 having an outer diameter of 20.8 mm are arranged coaxially with the backing roller 203. The backing roller 203 is supported by an arm 405 and is urged by springs 406 at a pressure of 5.9N. As a result, as shown in FIG. 4, the butt rollers 404 are butted against the sheet-passing surface 302a of the reading glass 302, so that the gap δ (FIG. 8) between the reading glass 302 and the backing roller 203 is held at 0.4 mm.

A rotational force is transmitted from a drive motor (not shown) to the end of the backing roller 203 on the right side (rear side) of FIG. 4 through a timing belt (not shown). The backing roller 203 rotates at the same conveyance speed as the first conveyance roller pair 201 and the second conveyance roller pair 206. This is to prevent the backing roller 203 from becoming a conveyance resistance of the sheet P when the sheet P passes through the gap δ (FIG. 8) between the reading glass 302 and the backing roller 203. Thus, paper dust generated when the sheet P passes through the backing roller 203 can be reduced.

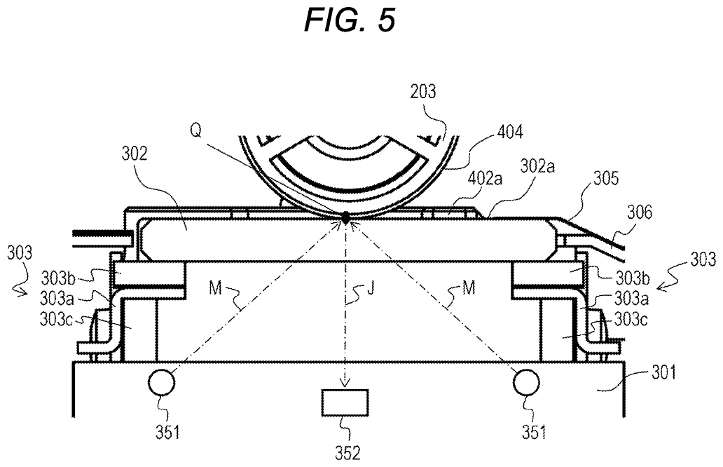

FIG. 5 is an explanatory view of a focal position Q of the CIS 301. The focal position Q of the CIS 301 is 0.2 mm±0.2 mm from the reading glass 302. By setting the gap δ (FIG. 8) between the reading glass 302 and the outer periphery of the backing roller 203 to 0.4 mm, no matter where the sheet P passes through the gap δ (FIG. 8), the sheet P passes through a focal region of the CIS 301, thereby ensuring good image reading. A light emitting portion 351 of the CIS 301 irradiates light M toward the focal position Q. A light receiving portion 352 of the CIS 301 receives light J.

A predetermined distance L between the upper surface T of the CIS 301 and the reading glass 302 shown in FIG. 3 is held by the CIS holders 401 and 402 shown in FIG. 4. The dustproof plate 303 is disposed between the CIS 301 and the reading glass 302. The sponge 303b is squeezed between the steel plate 303a and the reading glass 302. An original thickness of the sponge 303b before mounting is 3 mm. A thickness D of the sponge 303b squeezed after mounting is 2 mm. The sponge 303c is squeezed between the steel plate 303a and the CIS 301. An original width of the sponge 303c before mounting is 7 mm. A width E of the sponge 303c squeezed after mounting is 5.8 mm. Squeezing amounts of the sponges 303b and 303c are set to 1 mm and 1.2 mm, respectively.

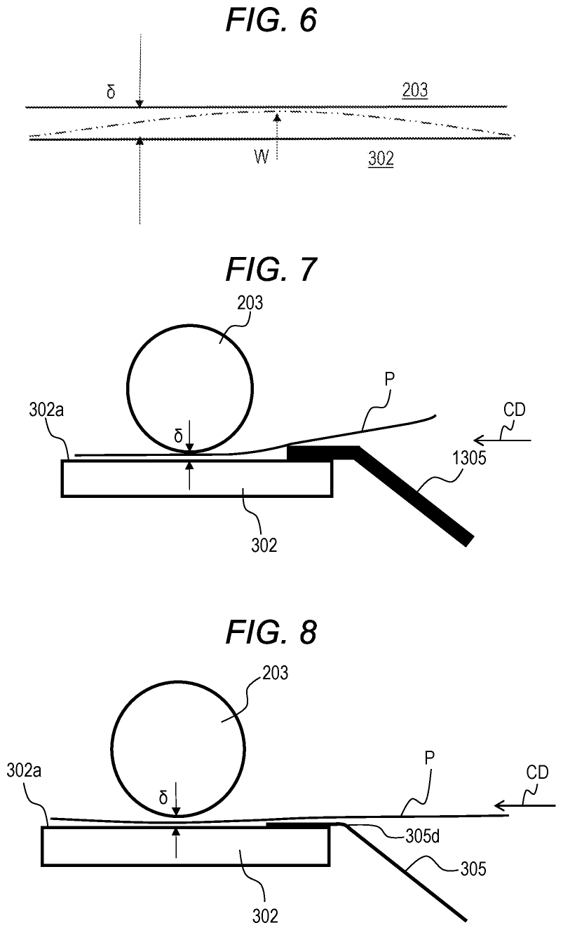

In this way, the sponges 303b and 303c are arranged in a state in which the sponges 303b and 303c are squeezed between the reading glass 302 and the CIS 301, thereby blocking the path through which foreign substances such as dirt and paper dust enter between the reading glass 302 and the CIS 301. However, the squeezed sponge 303b presses the reading glass 302 toward the backing roller 203 on the side (first side) on which the sheet P is conveyed. FIG. 6 is an explanatory view of the gap δ between the reading glass 302 and the backing roller 203. Due to a reaction force W generated when the sponge 303b is squeezed, the reading glass 302 deflects toward the backing roller 203 as indicated by the two-dot chain line in FIG. 6. If the reading glass 302 deflects toward the backing roller 203, the gap δ between the reading glass 302 and the backing roller 203 becomes smaller than the set value. In a case in which the gap δ becomes smaller than the set value, resistance may be generated in the conveyance of the sheet P in the gap δ between the reading glass 302 and the backing roller 203, or paper dust may be generated. Therefore, in the embodiment, the deflection of the reading glass 302 is suppressed by the introduction guide 305. Hereinafter, a mechanism configured to suppress the deflection of the reading glass 302 toward the backing roller 203 caused by the reaction force W generated when the sponge 303b is squeezed will be described.

(Introduction Guide)

In order to smoothly deliver the sheet P conveyed by the first conveyance roller pair 201 onto the reading glass 302, the introduction guide 305 is disposed upstream of the reading glass 302 in the conveyance direction CD. The introduction guide 305 is arranged on the side of the reading glass 302 with respect to a conveyance path in which the sheet P is conveyed. The introduction guide 305 can prevent the sheet P from being scratched by being caught on the end of the reading glass 302, the sheet P from being broken, or the sheet P from being jammed.

As described above, a line connecting the nip of the first conveyance roller pair 201 and the nip of the second conveyance roller pair 206 is arranged so as to substantially coincide with the sheet-passing surface 302a of the reading glass 302, thereby the sheet P is conveyed linearly during image reading. This is to reduce damage to an image of the sheet P and generation of paper dust by preventing deflecting stress from being applied to the sheet P during image reading. Therefore, a material requiring a thickness as a material for forming the introduction guide 305 is unsuitable. This is because a large deflecting stress is applied to the sheet P by a step (level difference) formed between the sheet-passing surface 302a of the reading glass 302 and the introduction guide 305, and image damage and paper dust are generated.

Hereinafter, a mechanism will be described in which a step formed by the sheet-passing surface 302a of the reading glass 302 and an introduction guide 1305 causes paper dust and image damage in a case in which the introduction guide 1305 having a large thickness is used in place of the introduction guide 305 according to the present embodiment. FIG. 7 is an explanatory view of the deflecting of the sheet P in a case in which the introduction guide 1305 of the reference example is used. The gap δ between the sheet-passing surface 302a of the reading glass 302 and the outer periphery of the backing roller 203 is set to 0.4 mm as described above. The introduction guide 1305 of the reference example is made of a steel plate having a thickness of 1 mm. The sheet P conveyed in the conveyance direction CD passes through the gap δ of 0.4 mm from a position having a height of 1 mm starting from the sheet-passing surface 302a of the reading glass 302. At this time, as shown in FIG. 7, the sheet P is slightly bent. Therefore, the sheet P and the introduction guide 1305 of the reference example are more rubbed, and paper dust is generated.

Next, a case in which the introduction guide 305 according to the present embodiment is used will be described with reference to FIG. 8. FIG. 8 is an explanatory view of the bending of the sheet P in a case in which the introduction guide 305 of the embodiment is used. The introduction guide 305 is made of a spring material having a thickness of 0.1 mm. The introduction guide 305 is provided with a bent portion 305d. The radius of curvature of the bent portion 305d is preferably 0.5 mm or more. The sheet P conveyed in the conveyance direction CD passes through the gap δ having a height of 0.1 mm from a position having a height of 0.4 mm starting from the sheet-passing surface 302a of the reading glass 302. Since the height of the step formed by the sheet-passing surface 302a of the reading glass 302 and the introduction guide 305 is 0.1 mm, the bending of the sheet P is suppressed. Thus, sliding resistance when the sheet P passes on the introduction guide 305 is reduced, and generation of paper dust is suppressed.

It is desirable that the height of the introduction guide 305 from the reading glass 302 is smaller than the gap δ between the reading glass 302 and the backing roller 203 and as low as possible. The introduction guide 305 of the embodiment is made of the spring material of SUS 304 CSP-1/2H having a thickness of 0.1 mm. By using the material having the thickness of 0.1 mm, the step caused by the reading glass 302 and the introduction guide 305 is reduced, and the generation of image damage and paper dust caused when the sheet P passes on the introduction guide 305 is reduced. The introduction guide 305 of the embodiment is preferably made of a thin spring material having the thickness of 0.1 mm. The spring material includes, for example, spring steel such as high carbon steel, alloy steel, and stainless steel.

As described above, the dustproof plate 303 configured to prevent foreign substance such as paper dust and dirt from entering is disposed between the CIS 301 and the reading glass 302 in the state in which the sponge 303b is squeezed. If the introduction guide 305 of the present embodiment is not provided on the reading glass 302, as shown in FIG. 6, the reading glass 302 deflects toward the backing roller 203 and deforms so that the gap δ between the reading glass 302 and the backing roller 203 becomes small. However, in the embodiment, the introduction guide 305 made of the spring material is disposed on the reading glass 302.

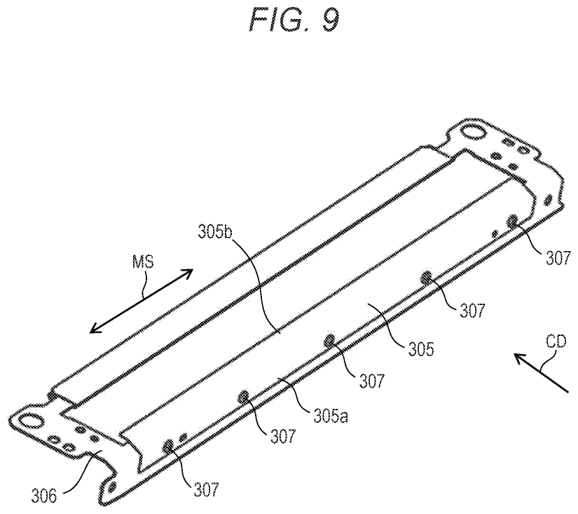

FIG. 9 is a view of the introduction guide 305 fixed to the frame 306. The introduction guide 305 extends in the main scanning direction MS. An end portion (hereinafter referred to as one end portion) 305a on an upstream side of the introduction guide 305 with respect to the conveyance direction (sub-scanning direction) CD of the sheet P is fixed to the frame 306 as a fixed end portion by a plurality of screws 307. The frame 306 is fixed to a casing 102a of the inspection apparatus 102 via another frame 411 (FIG. 4). Since the one end portion 305a as the fixed end of the introduction guide 305 is fixed to the frame 306 by the screws 307, the introduction guide 305 is surely grounded, and generation of static electricity can be prevented.

An end portion (hereinafter referred to as the other end portion) 305b on the downstream side of the introduction guide 305 with respect to the conveyance direction CD of the sheet P is a free end portion. When the frame 306 is attached to the another frame 411 by screws 410 (FIG. 4), the other end portion 305b, which is the free end portion of the introduction guide 305, is disposed so as to be in close contact with the upper surface of the reading glass 302. At this time, the other end portion 305b, which is the free end portion of the introduction guide 305, is attached so as to be in close contact with the reading glass 302 while being deformed by about 2.6 mm in the height direction. The other end portion 305b, which is the free end portion of the introduction guide 305 formed of the spring material (leaf spring), generates a spring force toward the reading glass 302. The other end portion 305b, which is the free end portion of the introduction guide 305, presses the reading glass 302 toward the side (second side) on which the first image reading apparatus 202 is disposed. The spring force of the introduction guide 305 can cancel the force of deflecting the reading glass 302 toward the backing roller 203 by the reaction force W generated when the sponge 303b is squeezed. That is, the other end portion 305b of the introduction guide 305 presses the reading glass 302 with a pressing force that suppresses deformation of the reading glass 302 by the sponge 303b and flattens the reading glass 302. Therefore, the sheet-passing surface 302a of the reading glass 302 is held in a substantially horizontal state by the introduction guide 305. The sheet P is conveyed without giving bending stress to the sheet P by the introduction guide 305.

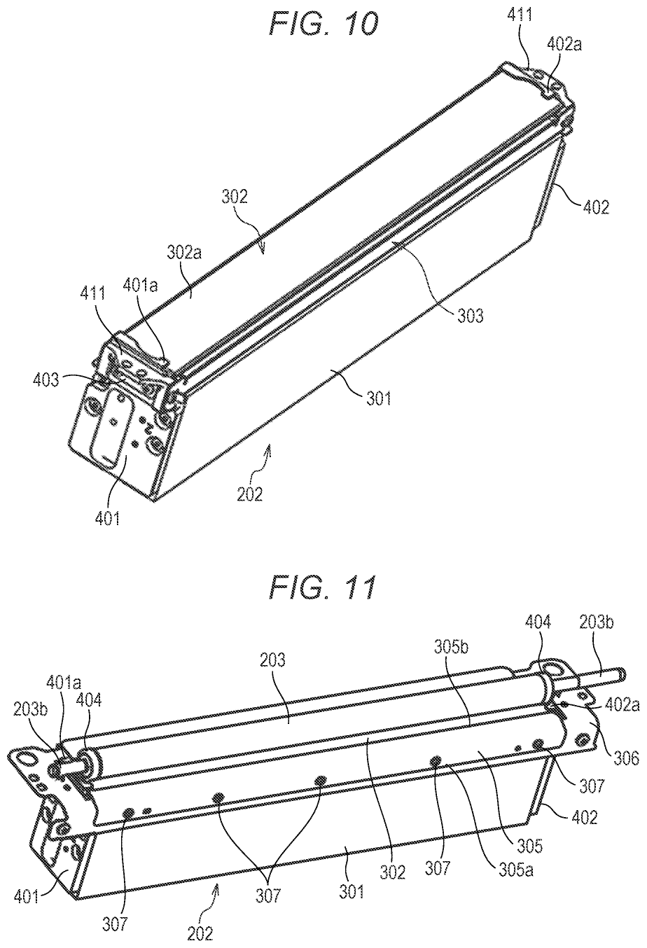

FIG. 10 is a perspective view of the first image reading apparatus 202. FIG. 11 is a perspective view of the first image reading apparatus 202 in which the frame 306, the introduction guide 305 and the backing roller 203 are assembled. The other end portion 305b, which is the free end portion of the introduction guide 305, is in close contact with the reading glass 302 to prevent the deflection of the reading glass. Further, since the step between the reading glass 302 and the introduction guide 305 is small, image damage and paper dust are suppressed when the sheet P passes on the reading glass 302, and image data with less noise can be read.

The first image reading apparatus 202 has been described above. The second image reading apparatus 204 is arranged in the direction opposite to that of the first image reading apparatus 202 with respect to the conveyance path of the sheet P. Since the configuration, functions and effects of the second image reading apparatus 204 are the same as those of the first image reading apparatus 202, a description of the second image reading apparatus 204 is omitted.

According to the embodiment, the deflection of the reading glass 302 can be reduced to improve the image reading performance.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-007005, filed Jan. 20, 2021, which is hereby incorporated by reference herein in its entirety.

What is claimed is:

1. An image reading apparatus configured to read an image of a sheet conveyed from an image forming apparatus configured to form the image on the sheet, the image reading apparatus comprising:
a conveyance portion configured to convey the sheet in a conveyance direction;
a transparent member including a first surface disposed on a first side on which the sheet is conveyed by the conveyance portion and a second surface disposed on a second side opposite to the first side;
an image reading portion disposed on the second side with respect to the transparent member and configured to read the image of the sheet through the transparent member;
an elastic member disposed to abut against the second surface of the transparent member on the second side and configured to press the transparent member toward the first side; and
a guide disposed upstream of a reading position where the image reading portion reads the image of the sheet with respect to the conveyance direction and configured to guide the sheet conveyed by the conveyance portion to the reading position,
wherein the guide is provided so that a downstream end of the guide with respect to the conveyance direction contacts with the first surface of the transparent member and presses the transparent member toward the second side.

2. The image reading apparatus according to claim 1, further comprising an opposed member opposed to the first surface of the transparent member,
wherein a thickness of the guide is smaller than a gap between the transparent member and the opposed member.

3. The image reading apparatus according to claim 1, further comprising a holding member configured to hold the image reading portion,
wherein the holding member holds the transparent member at a predetermined distance from the image reading portion, and
wherein the holding member has a positioning portion configured to position both ends of the transparent member with respect to a direction orthogonal to the conveyance direction on the first side.

4. The image reading apparatus according to claim 1, further comprising a casing,
wherein an upstream end of the guide with respect to the conveyance direction is fixed to the casing so as to be grounded.

5. The image reading apparatus according to claim 1, wherein the guide is provided with a bent portion, and
wherein a radius of curvature of the bent portion is 0.5 mm or more.

6. The image reading apparatus according to claim 1, wherein the guide presses the transparent member with a pressing force that suppresses a deformation of the transparent member by the elastic member to flatten the transparent member.

7. The image reading apparatus according to claim 1, further comprising a backing roller opposed to the first surface of the transparent member.

8. The image reading apparatus according to claim 1, wherein the elastic member is a sponge disposed to be squeezed between the transparent member and the image reading portion.

9. The image reading apparatus according to claim 1, wherein the guide is made of an elastic material.

10. The image reading apparatus according to claim 1, further comprising an inspection portion configured to perform an image inspection by comparing the image read by the image reading portion with a reference image.

11. An image forming system, comprising:
an image forming apparatus configured to form an image on a sheet; and
an image reading apparatus configured to read the image formed on the sheet by the image forming apparatus, the image reading apparatus, comprising:
a conveyance portion configured to convey the sheet in a conveyance direction;
a transparent member including a first surface disposed on a first side on which the sheet is conveyed by the conveyance portion and a second surface disposed on a second side opposite to the first side;
an image reading portion disposed on the second side with respect to the transparent member and configured to read the image of the sheet at a reading position through the transparent member;
an elastic member disposed to abut against the second surface of the transparent member on the second side and configured to press the transparent member toward the first side; and
a guide disposed upstream of the reading position with respect to the conveyance direction and configured to guide the sheet conveyed by the conveyance portion to the reading position,
wherein the guide is provided so that a downstream end of the guide with respect to the conveyance direction contacts with the first surface of the transparent member and presses the transparent member toward the second side.
